(19) United States
(12) Patent Application Publication
(10) Pub. No.: US 2011/0271720 A1
(43) Pub. Date: Nov. 10, 2011

(54) NOVEL DIAL-TYPE WINDOW LOCK

(75) Inventor: Daqiang Zheng, Zengcheng City (CN)

(73) Assignee: CMECH (GUANGZHOU) INDUSTRIAL LTD., ZENGCHENG CITY (CN)

(21) Appl. No.: 12/853,343

(22) Filed: Aug. 10, 2010

(30) Foreign Application Priority Data
May 4, 2010 (CN) 201020178871.X

(51) Int. Cl. E05B 65/00

(52) U.S. Cl. 70/89

(57) ABSTRACT

The present utility model discloses a novel dial-type window lock, comprising a lock body, a lock catch member and a dial handle, wherein the lock body is provided with a bush allowing a square shaft of the dial handle to movably pass there through, the lock catch member and the dial handle are respectively provided on internal and external sides of the lock body and remain linked to each other via the square shaft of the dial handle; the window lock further comprises an elastic seizure mechanism which allows for achievement of quick positioning when the lock catch member shifts between locked and opened states and which comprises an elastic seizure assembly disposed on the lock catch member and a snap slot disposed on the lock body and snap engaged with and interference fitted with the elastic seizure assembly. The present utility model has the following advantageous effects as compared with the prior art: 1. the window lock is small and compact in structure, easy to process and manufacture and feel good to operate; 2. The window lock is pragmatic and reliable with a long service life. Experimental data reveals that when the window lock is opened 70,000 times or more than 70,000 times, it is still functionally intact.

### FIELD OF THE TECHNOLOGY

The present utility model relates to a dial-type window lock, in the technical field of anti-theft locks, and particularly to a novel dial-type window lock with a modified structure.

### BACKGROUND

In modern society, there are innumerable types and models of locks with different structures and functions. Currently, dial-type locks are generally mounted on doors or windows which do no require too high anti-theft performance. The dial-type locks have advantages such as a simple structure, easy manufacture and convenient operations and are spread and extensively used in the office sites and household decoration. The patented utility model No. 98234269.1 entitled “push-pull type window lock” discloses a push-pull type window lock which employs a construction in which two metal spring tabs clamp a square shaft of a dial handle, thereby achieve the purpose of quick positioning when the dial handle shifts between a locked state and an opened state. However, since the square shaft rotates when being in a clamped state by the metal spring tabs, the wear there between is relatively serious and excessive wear will disenable the automatic positioning function of the lock and shorten the service life of the lock.

### SUMMARY

An object of the present utility model is to overcome drawbacks and shortcomings in the prior art and provide a novel dial-type window lock with a simplified structure, practicability and reliability and a long service life.

In order to achieve the above purpose, the present utility model is implemented by the following technical solution:

A novel dial-type window lock comprises a lock body, a lock catch member and a dial handle, wherein the lock body is provided with a bush allowing a square shaft of the dial handle to movably pass there through; the lock catch member and the dial handle are respectively provided on internal and external sides of the lock body and remain linked to each other via the square shaft of the dial handle. The window lock further comprises an elastic seizure mechanism which allows for achievement of quick positioning when the lock catch member shifts between the locked and opened states and which comprises an elastic seizure assembly disposed on the lock catch member and a snap slot disposed on the lock body and snap engaged with and interference fitted with the elastic seizure assembly.

Furthermore, the lock catch member is provided with a receiving cavity which has an opening and is used to place the elastic seizure assembly, wherein an axial direction of the receiving cavity is parallel with or perpendicular to an axial direction of the bush.

Furthermore, the elastic seizure assembly 4 comprises a telescopic spring and a ball, wherein the telescopic spring is disposed in the receiving cavity, the telescopic direction of the telescopic spring is parallel to the axial direction of the bush, and both ends of the telescopic spring respectively abut against and cooperate with an inner bottom of the receiving cavity and the ball. Part of a spherical surface of the ball extends out of the opening of the receiving cavity.

Furthermore, an inner wall of the lock body is provided with an arcuate guide rail corresponding to a rolling trajectory of the ball and being in a rolling and contacting cooperation with the ball. At both ends of the arcuate guide rail are respectively provided snap slots snap engaged with and interference fitted with the ball.

Furthermore, the elastic seizure assembly comprises a telescopic spring, a slider and a ball, wherein the telescopic spring is disposed in the receiving cavity, the telescopic direction of the spring is perpendicular to the axial direction of the bush, and both ends of the telescopic spring respectively abut against and cooperate with an inner bottom of the receiving cavity and an inner end of the slider. At an outer end of the slider is provided a groove for placing the ball. Part of a spherical surface of the ball extends out of the opening of the receiving cavity.

Furthermore, an arcuate outer wall of the bush of the lock body is in a rolling and contacting cooperation with the ball, and on the arcuate outer wall on an extension line of a diameter of an inner circle of the bush are provided snap slots which are snap engaged with and interference fitted with the ball.

Furthermore, an inclined guide surface is provided on the inner wall of each of the snap slots.

The present utility model has the following advantageous effects as compared with the prior art.

1. The window lock is small and compact in structure, easy to process and manufacture and feel good to operate;

2. The window lock is pragmatic and reliable with a long service life.

Experimental data reveals that when the window lock is opened 70,000 times or more than 70,000 times, it is still functionally intact.

Preferred embodiments of the window lock according to the present utility model will be described in detail with reference to the accompanying drawings to make the present utility model more clearly understood.

### BRIEF DESCRIPTION OF THE DRAWINGS

FIG. 1 is an exploded schematic view of a first embodiment according to the present utility model.

FIG. 2 is a cross-sectional view of the first embodiment according to the present utility model.

FIG. 3 is a schematic view of a lock catch member of FIG. 1.

FIG. 4a is a schematic view of the present utility model in a locked state.

FIG. 4b is a cross sectional view of an elastic seizure mechanism of FIG. 4a.

FIG. 5a is a schematic view of the present utility model in a moving state.

FIG. 5b is a cross sectional view of an elastic seizure mechanism of FIG. 5a.

FIG. 6a is a schematic view of the present utility model in an opened state.

FIG. 6b is a cross sectional view of an elastic seizure mechanism of FIG. 6a.

FIG. 7 is an exploded schematic view of a second embodiment according to the present utility model.

FIG. 8 is a schematic view of a lock catch member of FIG. 7.

### DETAILED DESCRIPTION

### Embodiment 1

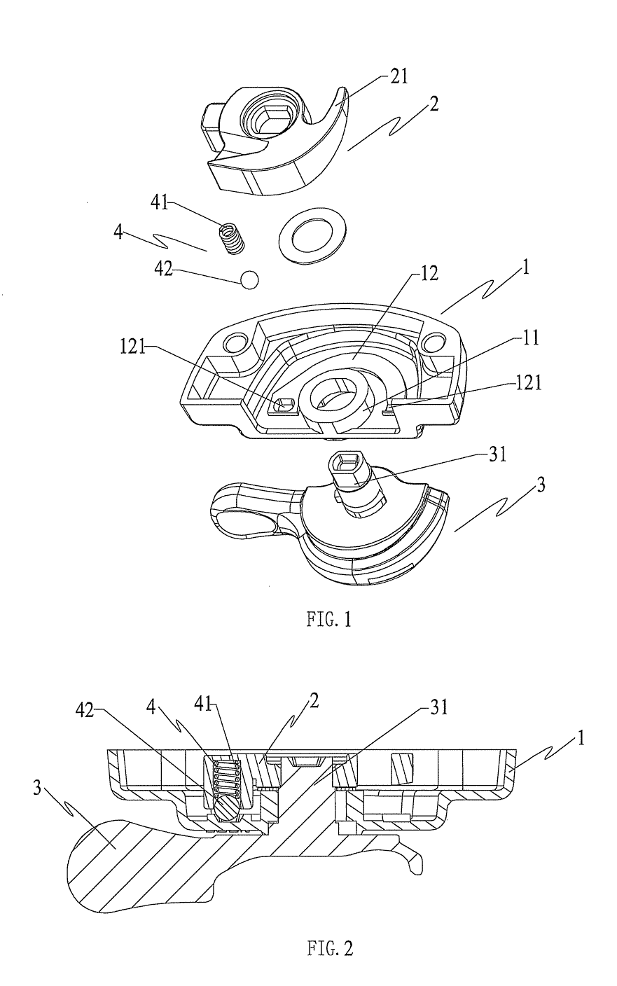

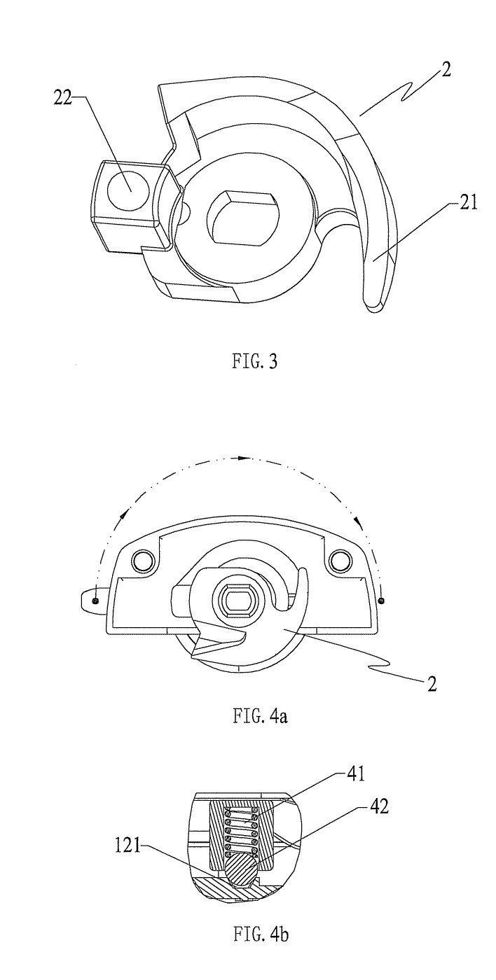

As shown in FIGS. 1-3, the novel dial-type window lock according to the present utility model comprises a lock body 1, a lock catch member 2, a dial handle 3 and an elastic seizure mechanism.

The lock body 1 is provided with a bush 11 allowing a square shaft 13 of the dial handle 3 to movably pass there through; the lock catch member 2 and the dial handle 3 are respectively provided on internal and external sides of the lock body 1 and remain linked to each other via the square shaft 31 of the dial handle 3. Furthermore, the lock catch member 2 is provided with a lock hook 21 in a locked cooperation with a latch disposed on a window frame, and a receiving cavity 22 which has an opening and is used to place an elastic seizure assembly, preferably, an axial direction of the receiving cavity 22 is parallel with an axial direction of the bush 11.

In another aspect, the elastic seizure mechanism allows for achievement of quick positioning when the lock catch member 2 shifts between the locked and opened states and comprises an elastic seizure assembly 4 disposed on the lock catch member 2 and a snap slot disposed on the lock body 1 and snap engaged with and interference fitted with the elastic seizure assembly. Furthermore, the elastic seizure assembly 4 comprises a telescopic spring 41 and a steel ball 42. The telescopic spring 14 is disposed in the receiving cavity 22 of the lock catch member 2, the telescopic direction of the telescopic spring is parallel to the axial direction of the bush 11, and both ends of the telescopic spring respectively abut against and cooperate with an inner bottom of the receiving cavity 22 and the ball 42. Part of a spherical surface of the ball 42 extends out of the opening of the receiving cavity 22. Preferably, an inner wall of the lock body 1 is also provided with an arcuate guide rail 12 corresponding to a rolling trajectory of the ball 42 and being in a rolling and contacting cooperation with the ball 42. At both ends of the arcuate guide rail 12 are respectively provided a firs snap slot 121 and a second snap slot 122 snap engaged with and interference fitted with the ball 42 to achieve locking positioning and opening positioning, and an inclined guide surface is provided on the inner wall of each of the first snap slot 121 and the second snap slot 122.

The working principle of the present utility model is as follows:

As shown in FIGS. 4a, 4b, the window lock is in a locked state, whereupon the ball 42 of the elastic seizure assembly is disposed, under an elastic force of the telescopic spring 41, in the first snap slot 121 and snap engaged with and interference fitted with the first snap slot 121 so that the lock catch member 2 achieves locking positioning.

As shown in FIGS. 5a, 5b, when the window lock is to be opened, the dial handle 3 is rotated and the lock catch member 2 linked thereto rotates therewith, thereby bringing the elastic seizure assembly into synchronous movement, driving the ball 42 to compress the telescopic spring 41 to roll from the first snap slot onto the arcuate trajectory 12 and move towards the second snap slot along the arcuate guide rail 12.

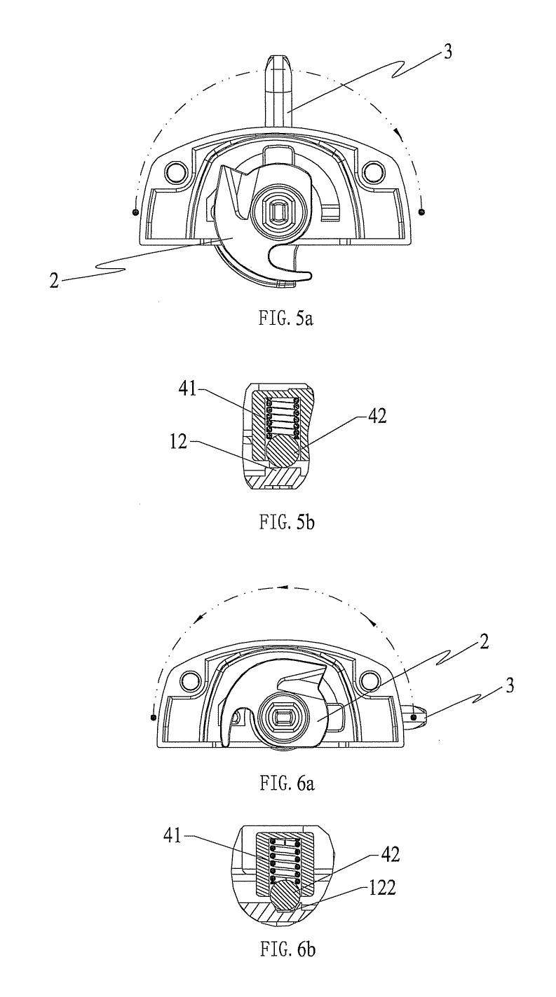

As shown in FIGS. 6a, 6b, when the elastic seizure assembly moves to the second snap slot 122, the ball 42 of the elastic seizure assembly is disposed, under the elastic force of the telescopic spring 41, in the second snap slot 122 and snap engaged with and interference fitted with the second snap slot 122, whereupon the window lock is in the opened state and the lock catch member 2 achieves opening positioning. If the window lock needs to be re-locked, what is to be done is to rotate the dial handle 3 reversely until the ball 41 of the elastic seizure assembly is snap engaged with and interference fitted with the first snap slot again, whereby the lock catch member 2 achieves quick positioning upon shifting between the locked state and the opened state.

### Embodiment 2

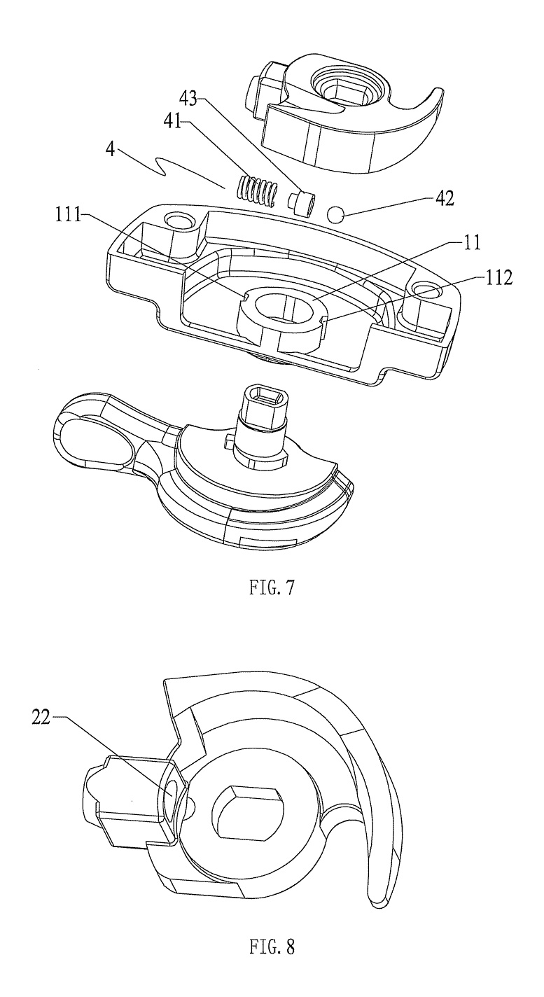

As shown in FIGS. 7, 8, the implementation mode of the present embodiment is substantially identical with that of the Embodiment 1. The only difference is that in the preset second embodiment the axial direction of the receiving cavity 22 is perpendicular to the axial direction of the bush 11. In another aspect, the elastic seizure assembly 4 comprises a telescopic spring 41, a slider 43 and a steel ball 42, wherein the telescopic spring 41 is disposed in the receiving cavity 22, the telescopic direction of the spring is perpendicular to the axial direction of the bush 11, and both ends of the telescopic spring respectively abut against and cooperate with an inner bottom of the receiving cavity 22 and an inner end of the slider 43. At an outer end of the slider 43 is provided a groove for placing the ball 42. Part of a spherical surface of the ball 42 extends out of the opening of the receiving cavity 22. Furthermore, an arcuate outer wall of the bush 11 of the lock body is in a rolling and contacting cooperation with the ball 42 to form a rolling trajectory of the ball 42, and on the arcuate outer wall on an extension line of a diameter of an inner circle of the bush are provided two snap slots, namely, a third snap slot 111 and a fourth snap slot 112, which are opposed to each other, snap engaged with and interference fitted with the ball 42 to achieve the locking positioning and the opening positioning. The remaining working principle and advantageous effects of the second embodiment are substantially identical with those in Embodiment 1.

The present utility model is not limited to the above embodiments. If various modification or variations to the present utility model do not depart from the spirit and scope of the present utility model, the present utility model also intends to contain the various modifications and variations if they fall within the scope of claims of the present utility model and equivalent technologies.

What is claimed is:

1. A novel dial-type window lock, comprising a lock body, a lock catch member and a dial handle, wherein the lock body is provided with a bush allowing a square shaft of the dial handle to movably pass there through, the lock catch member and the dial handle are respectively provided on internal and external sides of the lock body and remain linked to each other via the square shaft of the dial handle, characterized in that the window lock further comprises an elastic seizure mechanism which allows for achievement of quick positioning when the lock catch member shifts between locked and opened states and which comprises an elastic seizure assembly disposed on the lock catch member and a snap slot disposed on the lock body and snap engaged with and interference fitted with the elastic seizure assembly.

2. The novel dial-type window lock according to claim 1, characterized in that the lock catch member is provided with a receiving cavity which has an opening and is used to place the elastic seizure assembly, and in that an axial direction of the receiving cavity is parallel with or perpendicular to an axial direction of the bush.

3. The novel dial-type window lock according to claim 2, characterized in that the elastic seizure assembly comprises a telescopic spring and a ball, wherein the telescopic spring is disposed in the receiving cavity, the telescopic direction of the telescopic spring is parallel to the axial direction of the bush, and both ends of the telescopic spring respectively abut against and cooperate with an inner bottom of the receiving cavity and the ball, and in that part of a spherical surface of the ball extends out of the opening of the receiving cavity.

4. The novel dial-type window lock according to claim 3, characterized in that an inner wall of the lock body is provided with an arcuate guide rail corresponding to a rolling trajectory of the ball and being in a rolling and contacting cooperation with the ball, and at both ends of the arcuate guide rail are respectively provided snap slots snap engaged with and interference fitted with the ball.

5. The novel dial-type window lock according to claim 2, characterized in that the elastic seizure assembly comprises a telescopic spring, a slider and a ball, wherein the telescopic spring is disposed in the receiving cavity, the telescopic direction of the spring is perpendicular to the axial direction of the bush, and both ends of the telescopic spring respectively abut against and cooperate with an inner bottom of the receiving cavity and an inner end of the slider, in that an outer end of the slider is provided a groove for placing the ball, and in that part of a spherical surface of the ball extends out of the opening of the receiving cavity.

6. The novel dial-type window lock according to claim 5, characterized in that an arcuate outer wall of the bush of the lock body is in a rolling and contacting cooperation with the ball, and on the arcuate outer wall on an extension line of a diameter of an inner circle of the bush are provided snap slots which are snap engaged with and interference fitted with the ball.

7. The novel dial-type window lock according to claim 4, characterized in that an inclined guide surface is provided on the inner wall of each of the snap slots.
